(19) United States
(12) Patent Application Publication
(10) Pub. No.: US 2016/0050618 A1
(43) Pub. Date: Feb. 18, 2016

(54) Systems and Methods of Controlling Access of Multiple Radio Protocol Stacks Within a Subscription

(71) Applicant: QUALCOMM Incorporated, San Diego, CA (US)

(72) Inventors: Tirumala Rama Rao Kollu, Hyderabad (IN); Uday Kumar Arava, Hyderabad (IN); Amit Dubey, San Diego, CA (US); Praveen Gundameedi, Hyderabad (IN)

(21) Appl. No.: 14/457,309

(22) Filed: Aug. 12, 2014

(51) Int. Cl. H04W 48/18; H04W 8/18; H04W 36/00

(52) U.S. Cl. CPC H04W 48/18; H04W 36/0022; H04W 8/183; H04W 88/06

(57) ABSTRACT

Embodiments include systems and methods of controlling access to radio access protocol stacks within a subscription. A processor of a communication device may establish a connection to a communication network under a subscription associated with the communication device. The processor may select a protocol stack from among two or more protocol stacks associated with the subscription to communicate with the communication network. The processor may send an attention command to the selected protocol stack within the subscription.

### BACKGROUND

A mobile communication device that includes two or more subscriber identity module cards (“SIMs”) and connects to two or more separate mobile telephony networks (e.g., GSM, TDSCDMA, CDMA2000, WCDMA, WiMAX, and LTE) using one or more separate radio frequency (RF) communication circuits may be termed a “multi-SIM” or “MS” communication device. A “SIM,” “SIM card,” or “subscriber identification module” is a memory (e.g., an integrated circuit or embedded into a removable card) that stores an International Mobile Subscriber Identity (IMSI), related key, and/or other information used to identify and/or authenticate a wireless device on a network and enable a communication service with the network. A multi-SIM communication device can be configured to provide services and other communication capabilities that are unavailable to a communication device supporting a single SIM. For example, a multi-SIM communication device can be configured to provide simultaneous services in more than one domain, such as simultaneous GSM and LTE (e.g., SGLTE), simultaneous Voice and LTE (e.g., SVLTE), and the like, with two radio protocol stacks per subscription.

Certain radio access protocols may not support communications in certain domains. For example, LTE may not support voice domain communication (e.g., circuit switched communication). Workarounds have been proposed that enable a mobile communication device to utilize different domains at different times. For example, circuit switched fall back (CSFB) can provide circuit domain capabilities to an LTE modem through the use of a GSM or WCDMA communication network. However, such solutions require switching from the use of one radio protocol stack (e.g., LTE) to a second radio protocol stack (e.g., GSM or WCDMA) to enable access to the different communication domain.

### SUMMARY

Various embodiments provide methods, devices, and non-transitory processor-readable storage media for controlling access to radio access protocol stacks within a communication device for establishing a connection to a communication network under a subscription. Some embodiment methods may include selecting, by a processor of the communication device, a protocol stack from among two or more protocol stacks associated with the subscription for use in communicating with the communication network, and sending, by the processor to a modem associated with the selected protocol stack, a first attention (AT) command that includes a stack parameter that identifies the selected protocol stack. In some embodiments, the methods may further include sending, by the processor to a modem associated with the selected protocol stack, a second attention (AT) command configured to request information useful for communicating with the communication network. In some embodiments, among the two or more protocol stacks, a first protocol stack may include a circuit switched domain protocol stack and a second protocol stack may include a packet switched domain protocol stack. In some embodiments, the stack parameter in the first AT command may include a datum identifying one of the first protocol stack and the second protocol stack.

In some embodiments, the methods may include establishing a second connection to the communication network related to a second subscription, and selecting from among the first subscription and the second subscription to communicate with the communication network. In some embodiments, selecting, by a processor of the communication device, a protocol stack from among two or more protocol stacks associated with the subscription for use in communicating with the communication network may include selecting a protocol stack from among two or more protocol stacks associated with the selected first or second subscription. In some embodiments, sending, by the processor to a modem associated with the selected protocol stack, a first AT command that includes a stack parameter that identifies the selected protocol stack may include sending the first AT command to a modem maintaining the selected first or second subscription that includes a stack parameter that identifies the selected protocol stack to use in communicating via the selected subscription.

Various embodiments may include a communication device including a processor configured with processor-executable instructions to perform operations of the embodiment methods described above. Various embodiments may include a non-transitory processor-readable storage medium having stored thereon processor-executable software instructions configured to cause a processor to perform operations of the embodiment methods described above. Various embodiments may include a communication device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention, and not to limit the disclosed embodiments.

FIG. 1 is a communication system block diagram of communication networks suitable for use with various embodiments.

FIG. 2 is a component block diagram of a mobile communication device according to various embodiments.

FIG. 3 is a process flow diagram illustrating a method of controlling access to radio access protocol stacks within a subscription, according to various embodiments.

FIG. 4 is a process flow diagram illustrating another method of controlling access to radio access protocol stacks within a subscription, according to various embodiments.

FIG. 5 is a process flow diagram illustrating another method of controlling access to radio access protocol stacks within a subscription, according to various embodiments.

FIG. 6 is a process flow diagram illustrating another method of controlling access to radio access protocol stacks within a subscription, according to various embodiments.

FIG. 7 is a component block diagram of a mobile communication device suitable for use with various embodiments.

FIG. 8 is a component block diagram of another mobile communication device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The terms “communication device,” “mobile device,” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices which include a programmable processor and a memory. Various embodiments may be useful in mobile communication devices, such as smart phones, cellular telephones and other portable computing platforms. Various embodiments may be particularly useful in any devices that use radio protocol stacks to communicate with a communication network under a subscription.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A multi-SIM communication device may be configured to provide services and other communication capabilities that are unavailable to a communication device supporting a single SIM. For example, a multi-SIM communication device can be configured to provide simultaneous services in more than one domain, such as 3GPP Long Term Evolution (LTE) and Global System for Mobile Communications (GSM) (e.g., SGLTE), Voice and LTE (e.g., SVLTE), and other similar domains, with two radio protocol stacks per subscription.

Certain radio access technologies (RATs) may not support communications in certain domains. For example, an LTE RAT may not support voice domain communication (e.g., circuit switched communication). Workarounds have been proposed that enable a mobile communication device to utilize different domains at different times. For example, circuit switched fall back (CSFB) can provide circuit domain capabilities to an LTE modem through the use of a GSM or Wideband Code Division Multiple Access (WCDMA) communication network. However, such solutions require switching from the use of one radio protocol stack (e.g., LTE) to a second radio protocol stack (e.g., GSM or WCDMA) to enable access to the different communication domain.

A mobile communication device modem may be accessed through an attention (AT) command. AT commands can enable the issuing of commands and provide access to information needed to control a radio protocol stack, including RAT information, signal level information (such as received signal strength information), network registration information, and other similar commands and information. A multi-SIM communication device may include two (or more) radio protocol stacks per subscription. However, current chipsets do not provide the capability of accessing more than one radio protocol stack per subscription. Thus, in current chipsets, certain AT command functionality is unavailable because of the inability to address more than one radio protocol stack.

In overview, various embodiments provide methods implemented by a processor executing on a multi-SIM mobile communication device to control access to a first radio protocol stack and a second radio protocol stack in which the first and second radio protocol stacks are associated with one subscription of the communication device. A protocol stack command, which may be sent to one of the first radio protocol stack and the second radio protocol stack, may include a stack indicator. The stack indicator may enable the command to be directed to the first radio protocol stack or the second radio protocol stack.

In some embodiments, the protocol stack command may be addressed to, and may control access to, two radio protocol stacks per subscription. In some embodiments, the protocol stack command may be addressed to, and may control access to, two radio protocol stacks per subscription in a multi-SIM communication device configured to provide simultaneous services in more than one domain (e.g., SGLTE- or SVLTE-enabled communication devices). In some embodiments, methods implemented by a processor executing on a multi-SIM communication device may control access to protocol stacks of a first subscription and protocol stacks of a second subscription associated with the communication device. A protocol stack command to one of the first subscription and the second subscription may include a subscription indicator to enable direction of the command to the first subscription or the second subscription. The protocol stack command may also include a stack indicator to enable directing the command to a first radio protocol stack or a second radio protocol stack of the first subscription or to a third radio protocol stack or a fourth radio protocol stack of the second subscription, respectively. The methods may further be applied in a communication device comprising a greater number of chipsets. Thus, various embodiments may provide a protocol stack command that makes available substantially all functions of both radio protocol stacks within a subscription.

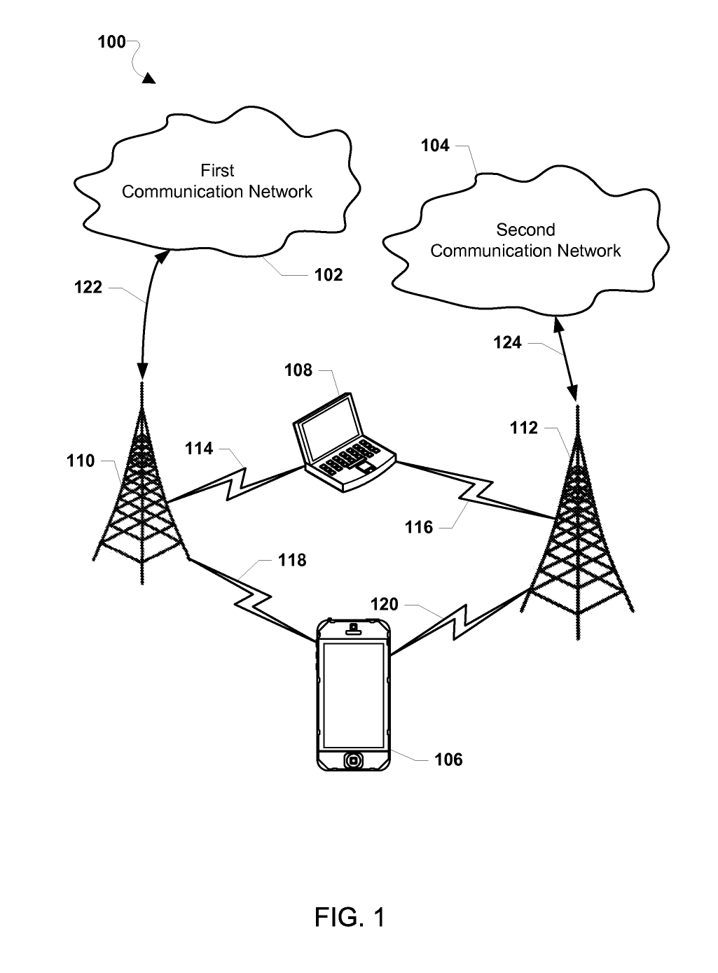

Various embodiments may be implemented within a variety of communication systems 100, particularly systems that include at least two communication networks, an example of which is illustrated in FIG. 1. A first communication network 102 and a second communication network 104 typically include a plurality of cellular base stations (e.g., a first base station 110 and a second base station 112). A first communication device 106 may be in communication with the first communication network 102 through a communication link 118 (e.g., a cellular connection) to the first base station 110. Additionally, or alternatively, the first communication device 106 may also be in communication with the second communication network 104 through a communication link 120 to the second base station 112. The first base station 110 may be in communication with the first communication network 102 over a wired or wireless communication link 122, which may include fiber optic backhaul links, microwave backhaul links, and other similar communication links. The second base station 112 may be in communication with the second communication network 104 over a wired or wireless communication link 124 similar to communication link 122. In some embodiments, the first and second communication networks 102, 104 may include mobile telephony communication networks.

A second communication device 108 may similarly communicate with the first communication network 102 through a communication link 114 to the first base station 110. The second communication device 108 may communicate with the second communication network 104 through a communication link 116 to the second base station 112. In some embodiments, the communication links 114, 116, 118, and 120 may include cellular connections that may be made through two-way wireless communication links using a wireless communication protocol such as LTE, Worldwide Interoperability for Microwave Access (WiMAX), CDMA, Time Division Multiple Access (TDMA), WCDMA, GSM, and other mobile telephony communication technologies. While the communication links 114, 116, 118, and 120 are illustrated as single links, the communication links 114, 116, 118 may include one or more links. In some embodiments, the first and second communication devices 106, 108 may communicate with the first base station 110 and/or the second base station 112 using more than one RAT.

The first and second communication devices 106, 108 may be associated with one or more subscriptions to enable access to the first and/or second communication networks 102, 104. In some embodiments, for a dual-SIM-dual-stack architecture in a wireless system, two registrations to two different wireless networks may be allowed. The dual stack architecture may emulate having two different modems allowing for two different network registrations. For example, a first stack could be registered to a first wireless network, such as GSM, and a second stack could be registered to a second wireless network, such as Universal Mobile Telecommunications System (UMTS).

The current 3GPP technical specification 27.007 does not provide options for a message or command (such as an attention (AT) command) that can be addressed to a particular protocol stack in a subscription. For example, a command to be sent between a communication device and a communication network must be processed by a protocol stack, and the command must therefore include information with which to select the proper protocol stack. As another example, when a request for a communication session is received by a communication device, the device typically requires information to identify the protocol which is used in the request. There may be many commands and/or messages which must utilize protocol stack selection criteria which are not covered by current specifications.

Thus, various embodiments provide a command configured to address a selected protocol stack under a subscription. In some embodiments, the command may be an AT command. The command may be configured to avoid interference with other existing commands (i.e., to allow existing commands to function properly). In some embodiments, the new command may be a $QCSTACK command which can be directed to a selected protocol stack under a subscription.

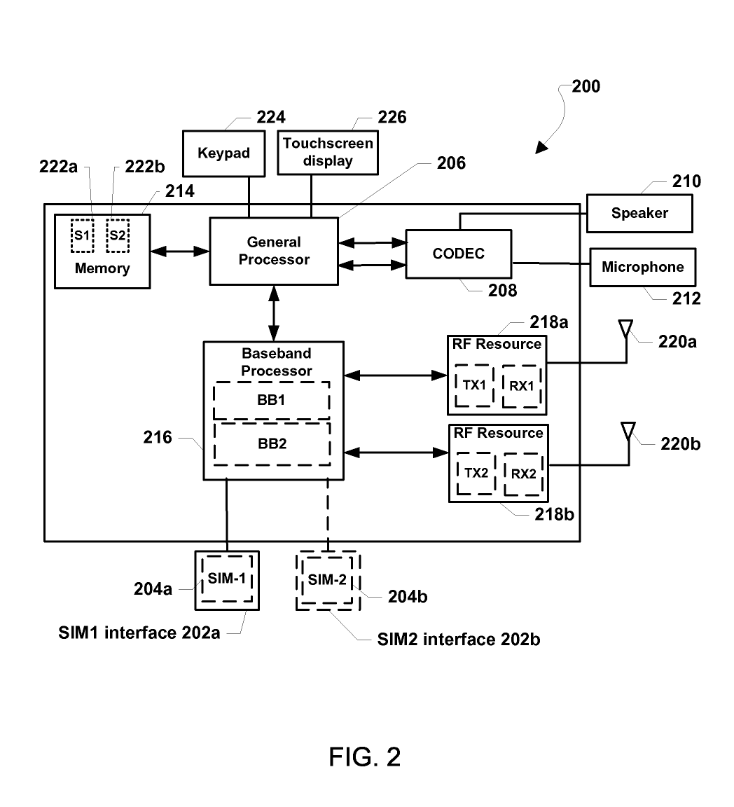

FIG. 2 is a functional block diagram of a mobile communication device 200 suitable for implementing various embodiments. In various embodiments, the mobile communication device 200 may be similar to one or more of the mobile communication devices 106, 108 as described with reference to FIG. 1. With reference to FIGS. 1-2, the mobile communication device 200 may include a first SIM interface 202a, which may receive a first identity module SIM-1 204a that is associated with a first subscription. The mobile communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

Each mobile communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure. The memory may also store instructions associated with a protocol stack such as protocol stack S1 222a and protocol stack S2 222b. A protocol stack generally is comprised of computer executable instructions to enable communication using a radio access protocol or communication protocol. Each protocol stack typically includes network protocol layers structured hierarchically to provide networking capabilities. A communication device may include one or more protocol stacks to enable communication using one or more radio access technologies.

A protocol stack may be associated with a SIM card and/or subscription. For example, the protocol stack S1 222a and the protocol stack S2 222b may be associated with the SIM-1 204a. The illustration of only two protocol stacks S1 222a and S2 222b is not intended as a limitation, and the memory 214 may store a plurality of protocol stacks (not illustrated). For example, the memory 214 may store a first plurality of protocol stacks, which may be associated with SIM-1 204a, and a second plurality of protocol stacks, which may be associated with SIM-2 204b. A communication device may include one or more protocol stacks associated with a subscription to enable communication with a communication network associated with the subscription using one or more radio access technologies.

The general purpose processor 206 and memory 214 may each be coupled to at least one baseband modem processor 216. Each SIM and/or RAT in the mobile communication device 200 (e.g., the SIM-1 204a and the SIM-2 204b) may be associated with a baseband-RF resource chain. For example, a first RAT (e.g., a GSM RAT) may be associated with an RF resource 218a, and a second RAT (e.g., a CDMA or WCDMA RAT) may be associated with an RF resource 218b.

Each baseband-RF resource chain may include the baseband modem processor 216 to perform baseband/modem functions for communicating with/controlling a RAT, and one or more amplifiers and radios, referred to generally herein as RF resources. In some embodiments, baseband-RF resource chains may share a common baseband modem processor 216 (i.e., a single device that performs baseband/modem functions for all RATs on the wireless device). Alternatively, each baseband-RF resource chain may include physically or logically separate baseband processors (e.g., BB1, BB2).

The RF resources 218a, 218b may be transceivers associated with one or more RATs and may perform transmit/receive functions for the wireless device on behalf of their respective RATs. The RF resources 218a, 218b may include separate transmit and receive circuitry. The RF resources 218a, 218b may each be coupled to a wireless antenna (e.g., a first wireless antenna 220a and a second wireless antenna 220b). The RF resources 218a, 218b may also be coupled to the baseband modem processor 216.

In some embodiments, the general purpose processor 206, the memory 214, the baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224 and a touchscreen display 226.

In some embodiments, the keypad 224, the touchscreen display 226, the microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in a mobile communication device 200 to enable communication between them, as is known in the art.

Functioning together, the two SIMs 204a, 204b, baseband processor BB1, BB2, RF resources 218a, 218b and antennas 220a, 220b may constitute two or more RATs. For example, one SIM, baseband processor, and RF resource may be configured to support two different radio access technologies. More RATs may be supported on a mobile communication device 200 by adding more SIM cards, SIM interfaces, RF resources, and antennae for connecting to additional mobile networks.

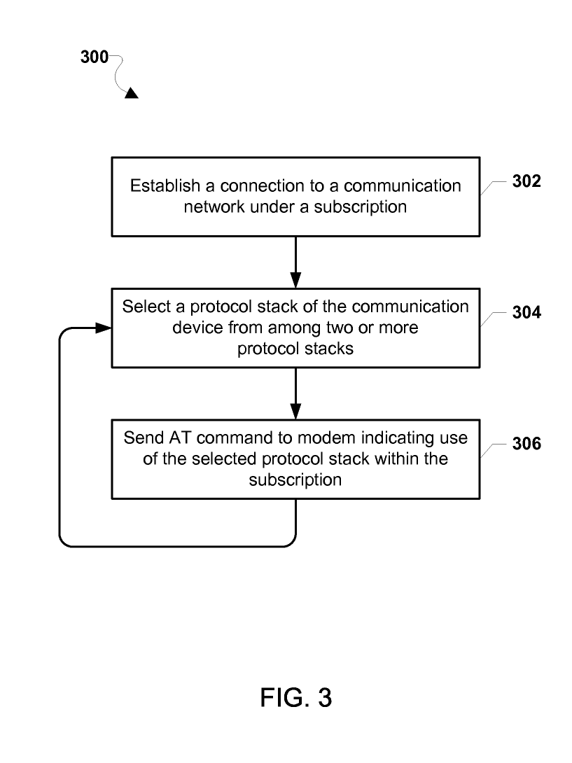

FIG. 3 illustrates a method 300 for controlling access to radio access protocol stacks within a subscription according to some embodiments. The method 300 may be implemented with a processor (e.g., the general purpose processor 206 of FIG. 2, the baseband modem processor 216, a separate controller, and/or the like) of a mobile communication device (e.g., the mobile communication device 200 of FIG. 2). With reference to FIGS. 1-3, in block 302, the communication device processor may establish a connection to a communication network under subscription associated with a communication device. For example, at the direction of the processor, the first communication device (e.g., the mobile communication device 106, 200) may establish communication with the first communication network. To initiate the connection, the first communication device may send a connection request to the first base station, an access point of the first communication network, to establish a communication link (e.g., the communication link 118), and upon a determination by the first base station that sufficient resources exist to support communication with the first communication device, the first base station may establish a connection with the first communication device. In some embodiments, the first base station may then pass a connection request to the first communication network through a communication link (e.g., the communication link 122). The first communication network may authenticate a subscription of the first communication device, and allocate network resources to support the connection between the first communication device and the first communication network. Allocated resources may include establishing logical communication links among network elements in the first communication network to support the communication session.

In block 304, the communication device processor may select a protocol stack from among two or more protocol stacks associated with the subscription to communicate with the communication network. For example, the communication device (e.g., at the direction of the processor) may select from among protocol stack S1 and protocol stack S2 to communicate with the first communication network. In some embodiments, the protocol stack may be selected based on the communication session to be established. For example, for a packet data communication session, a protocol stack for a first RAT may be selected (e.g., LTE), and for a voice communication session, a protocol stack for a second RAT may be selected (e.g., GSM).

In block 306, the communication device processor may send an attention (AT) command to the selected protocol stack within the subscription. An AT command may be used to address a communication-related command to a modem or other similar mechanism in a communication device. AT commands typically may be specific to a subscription, and also to a RAT within a subscription. For example, the first communication network may support communications using two RATs (e.g., LTE and GSM, WiMAX and CDMA, and other possible RAT combinations). To address an AT command related to communications with the first communication network, the AT command may be addressed to a SIM associated with a subscription enabling access to the first communication network. In implementations in which the first communication network supports communications in more than one RAT, the AT command may also be addressed to a protocol stack corresponding with the desired RAT. In some embodiments, a protocol stack command (which may include or be included in an AT command) may be sent to one of the first radio protocol stack and the second radio protocol stack, and may include a stack indicator. The stack indicator may enable the command to be directed to the first radio protocol stack or the second radio protocol stack. In some embodiments, the protocol stack command may be addressed to, and may control access to, two radio protocol stacks per subscription.

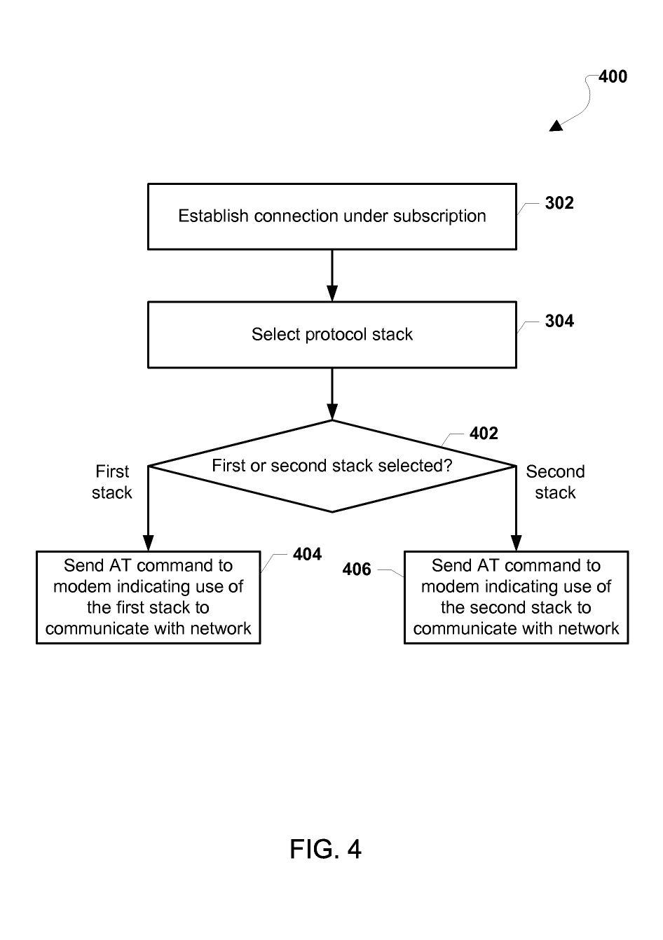

FIG. 4 illustrates a method 400 for controlling access to radio access protocol stacks within a subscription according to some embodiments. The method 400 may be implemented in a processor (e.g., the general purpose processor 206 of FIG. 2, the baseband modem processor 216, a separate controller, and/or the like) of a mobile communication device (e.g., the mobile communication device 200 of FIG. 2). With reference to FIGS. 1-4 and as described, in block 302, a communication device (e.g., 106, 200) may establish a connection to a communication network under subscription associated with a communication device. In block 304, the communication device processor may select a protocol stack from among two or more protocol stacks associated with the subscription to communicate with the communication network. In some embodiments of the operations performed in blocks 302-304, the communication device processor may perform operations similar to those described with reference to blocks 302-304 of the method 300.

In determination block 402, the communication device processor may determine the protocol stack that is selected. For example, a first or second protocol stack may be selected from among two protocol stacks associated with the subscription. In some embodiments, a communication device may be configured with more than two protocol stacks, each corresponding to one of a plurality of RATs. Configuring a communication device with more protocol stacks may enable the communication device to communicate using a wider range of RATs. In some embodiments, the communication device processor may determine whether a first protocol stack is selected, or whether a second protocol stack is selected. In response to determining that the first protocol stack is selected (i.e., determination block 402=“First stack”), the communication device processor may send an attention command to the modem (which may be the modem associated with the selected protocol stack) indicating that the selected first protocol stack will be used to communicate with the communication network (block 404). In response to determining that the second protocol stack is selected (i.e., determination block 402=“Second stack”), the communication device processor may send an attention command to the modem (which may be the modem associated with the selected protocol stack) indicating that the selected second protocol stack will be used to communicate with the communication network (block 406).

To communicate with the communication network (e.g., in block 404 or 406), the communication device processor may send an AT command to the modem associated with the selected protocol stack within the subscription. In some embodiments, sending the AT command may include using the AT command to address a second AT command to the modem associated with the selected protocol stack within the subscription. Table 1 illustrates example first commands and second commands:

TABLE 1

| COMMAND | FUNCTION |
|---|---|
| AT$QCSTACK=0 | Select first protocol stack |
| AT+COPS? | Obtain PLMN operator name and |
| | RAT for first protocol stack |
| AT$QCSTACK=1 | Select second protocol stack |
| AT+COPS? | Obtain PLMN operator name and |
| | RAT for second protocol stack |

A first AT command may include an indicator of the protocol stack that is selected (e.g., the first or second protocol stack), illustrated in Table 1 as “AT$QCSTACK=0” and “AT$QCSTACK=1,” in which the numerals 0 and 1 may function as an indicator of the first or second protocol stack, respectively. The second AT command may include a request for information related to the use of the selected protocol stack, illustrated in Table 1 as “AT+COPS?.” The second AT command may function to obtain information about a communication network, such as the operator and available radio access technology, and/or to determine a network registration status of the communication device.

Table 2 illustrates first commands and second commands that may be implemented in some embodiments:

TABLE 2

| COMMAND | FUNCTION |
|---|---|
| AT$QCSTACK=0 | Select first protocol stack |
| AT+CREG=1 | Report unsolicited result code |
| AT$QCSTACK=1 | Select second protocol stack |
| AT+CREG=1 | Report unsolicited result code |

Similar to Table 1, a first AT command illustrated in Table 2 may include an indicator of the protocol stack that is selected (e.g., the first or second protocol stack), illustrated in Table 1 as “AT$QCSTACK=0” and “AT$QCSTACK=1,” in which the numerals 0 and 1 may indicate the first or second protocol stack, respectively. As illustrated in Table 2, the second AT command may include a report of information related to the use of the selected protocol stack, illustrated in Table 2 as “AT+CREG=1.” The second AT command may provide information about the registration status and radio access technology of a base station in communication with the communication device. It will be appreciated that other commands may be used as second commands to a selected protocol stack within a subscription.

The stack indicator in the first AT command (see, e.g., Tables 1 and 2) may enable the second AT command to be directed to the modem associated with the first radio protocol stack or the second radio protocol stack. The second AT command may thus be addressed to, and may control access to, one of two or more radio protocol stacks per subscription.

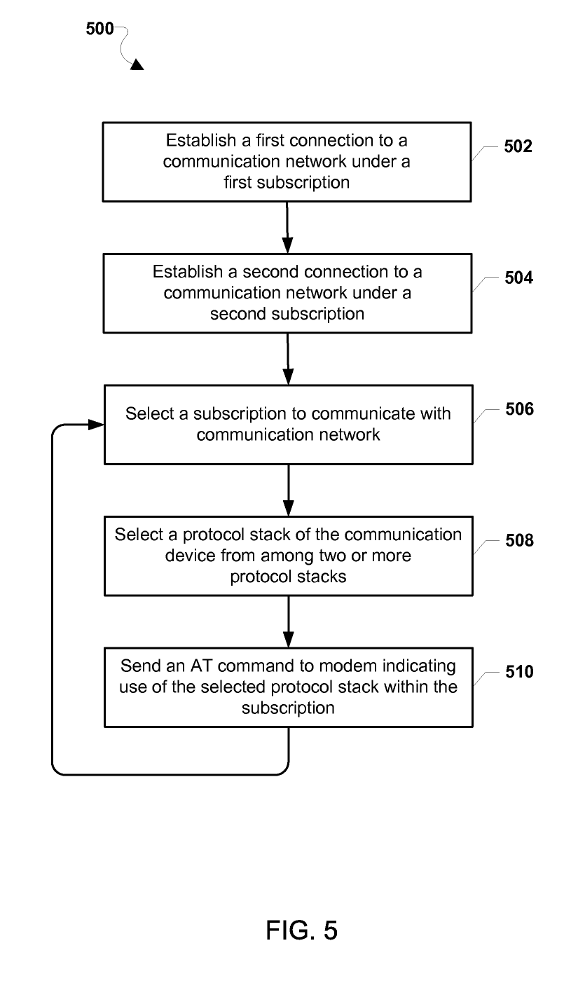

FIG. 5 illustrates a method 500 for controlling access to radio access protocol stacks within a subscription according to some embodiments according to some embodiments. The method 500 may be implemented with a processor (e.g., the general purpose processor 206 of FIG. 2, the baseband modem processor 216, a separate controller, and/or the like) of a mobile communication device (e.g., the mobile communication device 200 of FIG. 2). With reference to FIGS. 1-5, in block 502, a communication device may establish a first connection to a communication network under a first subscription associated with the communication device. For example, the first communication device (e.g., the first communication device 106, 200) may establish communication with the first communication network (e.g., the first communication network 102). To initiate the connection, the first communication device may send a connection request to the first base station, an access point of the first communication network, to establish a communication link, and upon a determination by the first base station that sufficient resources exist to support communication with the first communication device, the first base station may establish a connection with the first communication device. In some embodiments, the first base station may pass a connection request to the first communication network through a communication link (e.g., via the communication link 122). The first communication network may authenticate a subscription of the first communication device, and allocate network resources to support the connection between the first communication device and the first communication network. Allocated resources may include establishing logical communication links among network elements in the first communication network to support the communication session.

In block 504, the communication device may establish a second connection to a communication network under a second subscription associated with the communication device. For example, the communication device may send a second connection request to a base station, and the base station may pass the second connection request to the first communication network. In some embodiments, the first communication network and the first base station may support communications using two or more radio access technologies, and the communication device may communicate with the communication network using the two or more radio access technologies. As another example, the communication device may send the second connection request to a base station (e.g., the second base station 112), and the base station may pass the second request to a second communication network (e.g., the second communication network 104). In some embodiments, the second communication network and the second base station may support communications using the same or different radio access technologies as the first communication network and the first base station.

In block 506, the communication device processor may select from among the first subscription and the second subscription to communicate with the communication network. For example, the communication device processor may select the first subscription associated with the communication device to communicate with the first communication network. The communication device processor may also select the second subscription associated with the communication device to communicate with the second communication network. In some embodiments, the subscription may be selected based on the communication session to be established based on criteria including to avoid roaming charges, based on network congestion, based on available network resources in the first and second communication networks, based on available wireless communication resources in the first and second communication networks, and/or based on one or more other similar criteria.

In block 508, the communication device processor may select from among two or more protocol stacks associated with the selected subscription to communicate with the communication network. For example, the communication device processor may select from among a first protocol stack (e.g., protocol stack S1) and a second protocol stack (e.g., protocol stack S2) to communicate with the communication network. In some embodiments, the protocol stack may be selected based on the communication session to be established. For example, for a packet data communication session, a protocol stack for a first RAT may be selected (e.g., LTE), and for a voice communication session, a protocol state for a second RAT may be selected (e.g., GSM).

In block 510, the communication device processor may send an attention (AT) command to the modem associated with the selected protocol stack within the subscription. The AT command may be used to address a communication-related command to the modem in a communication device. To address an AT command related to communications with the first communication network, the communication device processor may address the AT command to a SIM associated with the selected subscription. In situations in which the first communication network supports communications using more than one RAT, the communication device processor may address the AT command to modem associated with a protocol stack corresponding to the desired RAT. In some embodiments, a protocol stack command (which may include or be included in an AT command) may be sent to one of a modem associated with the first radio protocol stack and the second radio protocol stack, and may include a stack indicator. The stack indicator may enable the command to direct the modem to use either the first radio protocol stack or the second radio protocol stack. Thus, in some embodiments, the protocol stack command may be used by the processor to control access to two radio protocol stacks per subscription.

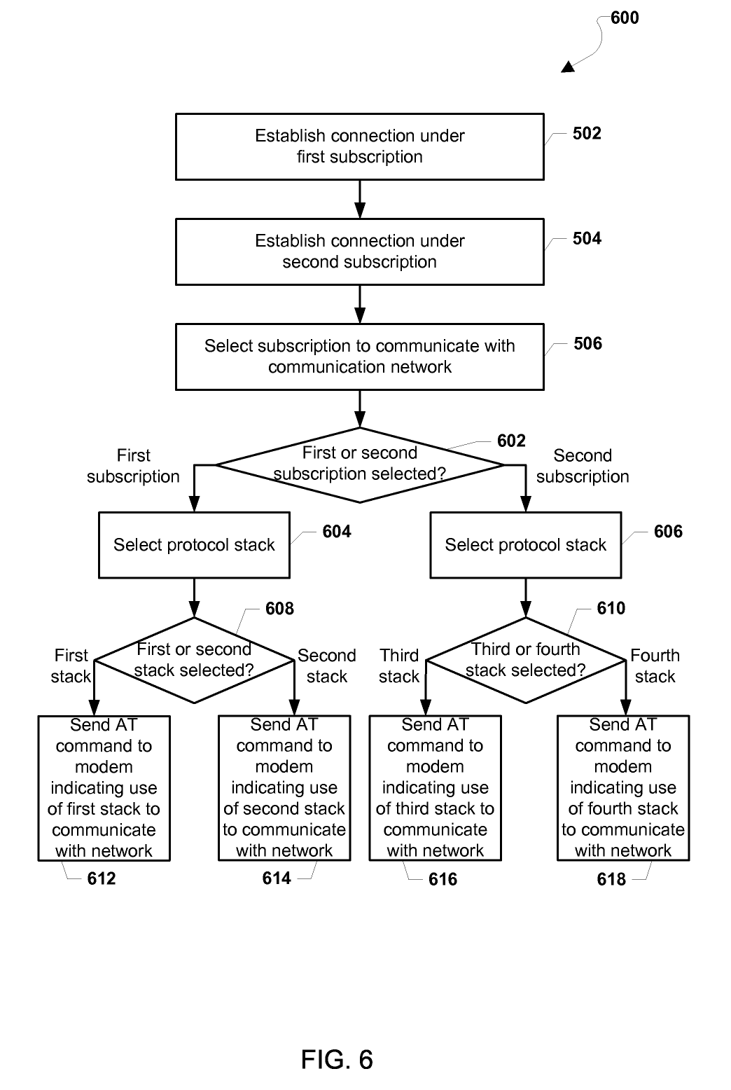

FIG. 6 illustrates a method 600 for controlling access to radio access protocol stacks within a subscription according to some embodiments. The method 600 may be implemented by a processor (e.g., the general purpose processor 206 of FIG. 2, the baseband modem processor 216, a separate controller, and/or the like) of a mobile communication device (e.g., the mobile communication device 200 of FIG. 2). With reference to FIGS. 1-6, in block 502, a communication device (e.g., 106, 200) may establish a first connection to a communication network under a first subscription associated with the communication device (see FIG. 5). In block 504, the communication device may establish a second connection to a communication network (which may be the same communication network or a different communication network) under a second subscription associated with the communication device. In block 506, the communication device processor may select from among the first subscription and the second subscription to communicate with the communication network. In some embodiments of the operations performed in blocks 502-506, the communication device processor may perform operations similar to those described with reference to blocks 502-506 of the method 500 (see FIG. 5).

In determination block 602, the communication device processor may determine whether the first subscription or the second subscription is selected. In response to determining that the first subscription is selected (i.e., determination block 602=“First subscription”), the communication device processor may select from among two or more protocol stacks associated with the first subscription to communicate with the communication network (block 604). In determination block 608, the communication device processor may determine whether the first or second protocol stack is selected. In response determining that the first protocol stack is selected (i.e., determination block 608=“First stack”), the communication device processor may send an attention (i.e., AT) command to the modem associated with the first protocol stack, which is associated with the first subscription, to communicate with the communication network using the first protocol stack (block 612). In response to determining that the second protocol stack is selected (i.e., determination block 608=“Second stack”), the communication device processor may send an attention (i.e., AT) command to the modem associated with the second protocol stack, which is also associated with the first subscription, to communicate with the communication network using the second protocol stack (block 614).

Similarly, in response to determining that the second subscription is selected (i.e., determination block 602=“Second subscription”), the communication device processor may select from among two or more protocol stacks associated with the second subscription to communicate with the communication network (block 606). In determination block 610, the communication device processor may determine whether a third or a fourth protocol stack, which are associated with the second subscription, is selected. In response to determining that the third protocol stack is selected (i.e., determination block 610=“Third stack”), the communication device processor may send an attention (i.e., AT) command to the modem associated with the third protocol stack, which is associated with the second subscription, to communicate with the communication network using the selected third protocol stack (block 616). In response to determining that the fourth protocol stack is selected (i.e., determination block 610=“Fourth stack”), the communication device processor may send an attention (i.e., AT) command to the modem associated with the fourth protocol stack, which is also associated with the second subscription, to communicate with the communication network using the fourth protocol stack (block 618).

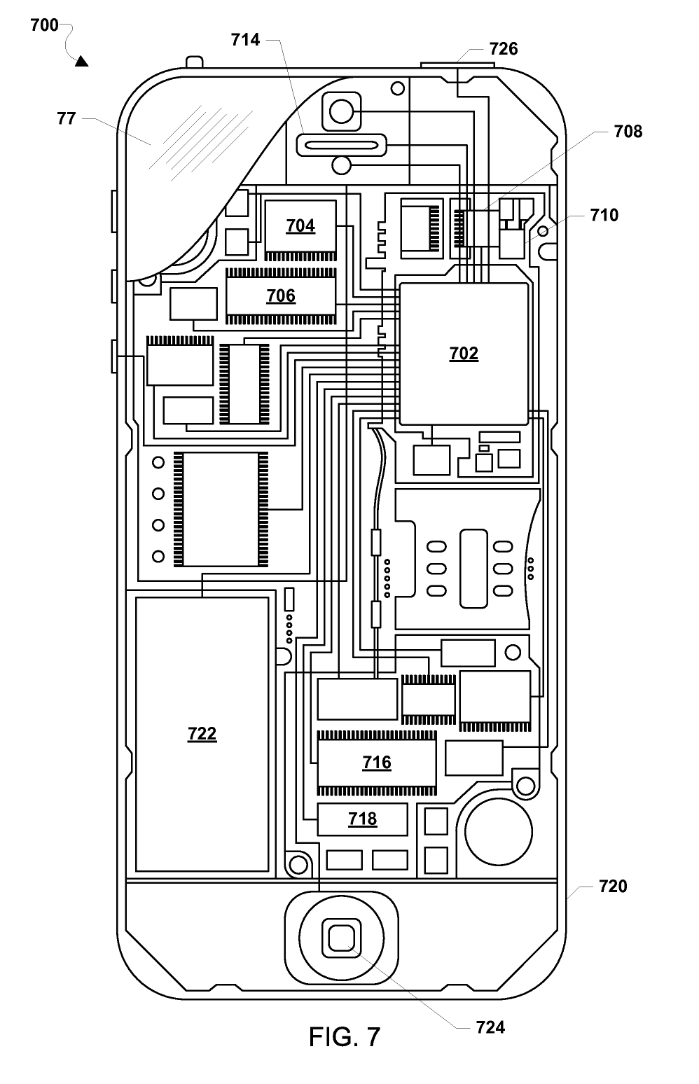

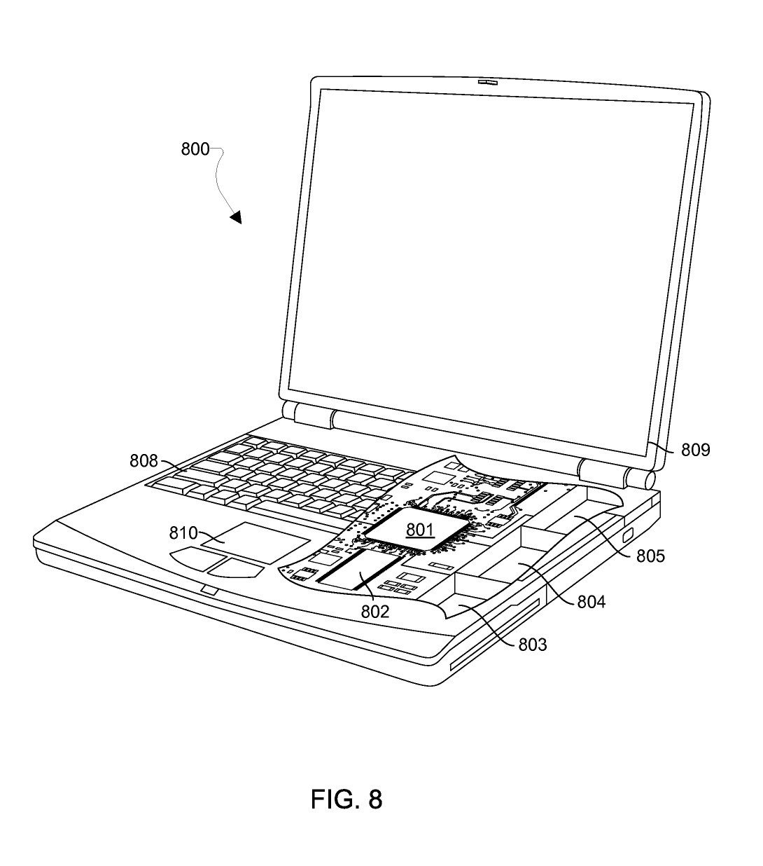

Various embodiments may be implemented in any of a variety of mobile communication devices, examples of which (e.g., a mobile communication device 700 and a laptop computer 800) are illustrated in FIGS. 7 and 8. In various embodiments, the mobile communication device 700 and the laptop computer 800 may be similar to the mobile communication devices 106, 108, 200 as described with reference to FIGS. 1-2. As such, the mobile communication device 700 and the laptop computer 800 may implement the methods 300, 400, 500, 600 of FIGS. 3-6.

With reference to FIGS. 1-8, the mobile communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the mobile communication device 700 need not have touch screen capability.

The mobile communication device 700 may have two or more radio signal transceivers 708 (e.g., Peanut, Bluetooth, Zigbee, Wi-Fi, RF radio) and antennae 710, for sending and receiving communications, coupled to each other and/or to the processor 702. The transceivers 708 and antennae 710 may be used with the above-mentioned circuitry to implement the various wireless transmission protocol stacks and interfaces. The mobile communication device 700 may include one or more cellular network wireless modem chip(s) 716 coupled to the processor and antennae 710 that enables communication via two or more cellular networks via two or more radio access technologies.

The mobile communication device 700 may include a peripheral device connection interface 718 coupled to the processor 702. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

The mobile communication device 700 may also include speakers 714 for providing audio outputs. The mobile communication device 700 may also include a housing 720, constructed of a plastic, metal, or a combination of materials, for containing all or some of the components discussed herein. The mobile communication device 700 may include a power source 722 coupled to the processor 702, such as a disposable or rechargeable battery. The rechargeable battery may also be coupled to the peripheral device connection port to receive a charging current from a source external to the mobile communication device 700. The mobile communication device 700 may also include a physical button 724 for receiving user inputs. The mobile communication device 700 may also include a power button 726 for turning the mobile communication device 700 on and off.

The laptop computer 800 may include a processor 801 coupled to volatile memory 802 and a large capacity nonvolatile memory, such as a disk drive 803. The laptop computer 800 may also include a compact disc (CD) and/or DVD drive 804 coupled to the processor 801. The laptop computer 800 may also include a number of connector ports coupled to the processor 801 for establishing data connections or receiving external memory devices, such as a network connection circuit 805 for coupling the processor 801 to a network. The laptop computer 800 may further be coupled to a keyboard 808, a pointing device such as a mouse 810, and a display 809 as is well known in the computer arts.

The processors 701 and 801 may be any programmable microprocessor, microcomputer or multiple processor chip or chips that can be configured by software instructions (applications) to perform a variety of functions, including the functions of various embodiments described below. In some mobile devices, multiple processors 701 may be provided, such as one processor dedicated to wireless communication functions and one processor dedicated to running other applications. Typically, software applications may be stored in the internal memories 702 and 802 before they are accessed and loaded into the processor 701 and 801. The processor 701 and 801 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

While the foregoing describes that a threshold may be met when a value is greater than or equal to the threshold, it will be appreciated that this is not a limitation, and that In some embodiments a threshold may be met when a value exceeds the threshold and not met when the value is less than or equal to the threshold.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of controlling access to radio access protocol stacks within a communication device, comprising:
establishing a first connection to a communication network under a first subscription;
selecting, by a processor of the communication device, a protocol stack from among two or more protocol stacks associated with the first subscription for use in communicating with the communication network; and
sending, by the processor to a modem associated with the selected protocol stack, a first attention (AT) command that includes a stack parameter that identifies the selected protocol stack.

2. The method of claim 1, further comprising sending, by the processor to the modem associated with the selected protocol stack, a second attention (AT) command configured to request information useful for communicating with the communication network.

3. The method of claim 1, wherein among the two or more protocol stacks, a first protocol stack comprises a circuit switched domain protocol stack and a second protocol stack comprises a packet switched domain protocol stack.

4. The method of claim 3, wherein the stack parameter in the first AT command includes data identifying one of the first protocol stack and the second protocol stack.

5. The method of claim 1, further comprising:
establishing a second connection to the communication network related to a second subscription; and
selecting from among the first subscription and the second subscription to communicate with the communication network,
wherein selecting a protocol stack from among two or more protocol stacks associated with the first subscription for use in communicating with the communication network comprises selecting a protocol stack from among two or more protocol stacks associated with the selected first or second subscription, and
wherein sending a first AT command that includes a stack parameter that identifies the selected protocol stack comprises sending the first AT command to a modem maintaining the selected first or second subscription that includes a stack parameter that identifies the selected protocol stack to use in communicating via the selected subscription.

6. The method of claim 1, further comprising:
establishing a second connection to a second communication network under a second subscription; and
selecting from among the first subscription and the second subscription to communicate with the communication network and the second communication network, respectively,
wherein selecting a protocol stack from among two or more protocol stacks associated with the first subscription for use in communicating with a communication network comprises selecting a protocol stack from among two or more protocol stacks associated with the selected first or second subscription, and
wherein sending, a first AT command that includes a stack parameter that identifies the selected protocol stack comprises sending the first AT command to a modem maintaining the selected first or second subscription that includes a stack parameter that identifies the selected protocol stack to use in communicating via the selected subscription.

7. The method of claim 6, wherein sending the first AT command to a modem maintaining the selected first or second subscription that includes a stack parameter that identifies the selected protocol stack to use in communicating via the selected subscription comprises:
determining which of the two or more protocol stacks associated with the selected first or second subscription is selected; and
sending the first AT command to the modem maintaining the selected first or second subscription that includes a stack parameter that identifies the determined protocol stack to use in communicating with the respective communication network.

8. A communication device, comprising:
two modems each associated with one or more protocol stacks; and
a processor coupled to each modem and configured to:
select a protocol stack from among the one or more protocol stacks associated with a respective subscription; and
send, to the modem associated with the selected protocol stack, a first attention (AT) command that includes a stack parameter that identifies the selected protocol stack.

9. The communication device of claim 8, wherein the processor is configured to send a second attention (AT) command configured to request information useful for communicating with a communication network.

10. The communication device of claim 8, wherein among the one or more protocol stacks, a first protocol stack comprises a circuit switched domain protocol stack and a second protocol stack comprises a packet switched domain protocol stack.

11. The communication device of claim 10, wherein the stack parameter in the first AT command includes data identifying one of the first protocol stack and the second protocol stack.

12. The communication device of claim 8, wherein the processor is further configured to:
select a subscription from among the respective subscriptions to communicate with the respective communication network;
select a protocol stack from among the one or more protocol stacks associated with the selected subscription; and
send the first AT command that includes a stack parameter that identifies the selected protocol stack to the modem associated with the selected protocol stack to communicate via the selected subscription.

13. The communication device of claim 12, wherein the processor is configured to send the first AT command to a modem maintaining the selected first or second subscription that includes a stack parameter that identifies the selected protocol stack to use in communicating via the selected subscription by:
determining which of two or more protocol stacks associated with the selected first or second subscription is selected; and
sending the first AT command to the modem maintaining the selected first or second subscription that includes a stack parameter that identifies the determined protocol stack to use in communicating with the respective communication network.

14. A non-transitory processor-readable storage medium having stored thereon processor-executable software instructions configured to cause a processor of a communication device to perform operations for controlling access to radio access protocol stacks to establish a connection to a communication network under a subscription, the operations comprising:
selecting a protocol stack from among two or more protocol stacks associated with a first subscription for use in communicating with the communication network; and
sending to a modem associated with the selected protocol stack a first attention (AT) command that includes a stack parameter that identifies the selected protocol stack.

15. The non-transitory processor-readable storage medium of claim 14, wherein the stored processor-executable software instructions are configured to cause a processor of a communication device to perform operations further comprising sending to the modem associated with the selected protocol stack, a second attention (AT) command configured to request information useful for communicating with the communication network.

16. The non-transitory processor-readable storage medium of claim 14, wherein among the two or more protocol stacks, a first protocol stack comprises a circuit switched domain protocol stack and a second protocol stack comprises a packet switched domain protocol stack.

17. The non-transitory processor-readable storage medium of claim 16, wherein the stack parameter in the first AT command includes data identifying one of the first protocol stack and the second protocol stack.

18. The non-transitory processor-readable storage medium of claim 14, wherein the stored processor-executable software instructions are configured to cause a processor of a communication device to perform operations further comprising:
establishing a second connection to the communication network related to a second subscription; and
selecting from among the first subscription and the second subscription to communicate with the communication network,
wherein selecting a protocol stack from among two or more protocol stacks associated with the subscription for use in communicating with the communication network comprises selecting a protocol stack from among two or more protocol stacks associated with the selected first or second subscription, and
wherein sending to a modem associated with the selected protocol stack a first AT command that includes a stack parameter that identifies the selected protocol stack comprises sending the first AT command to a modem maintaining the selected first or second subscription that includes a stack parameter that identifies the selected protocol stack to use in communicating via the selected subscription.

19. The non-transitory processor-readable storage medium of claim 18, wherein the stored processor-executable software instructions are configured to cause a processor of a communication device to perform operations further comprising sending the first AT command to a modem maintaining the selected first or second subscription that includes a stack parameter that identifies the selected protocol stack to use in communicating via the selected subscription by:
determining which of the two or more protocol stacks associated with the selected first or second subscription is selected; and
sending the first AT command to the modem maintaining the selected first or second subscription that includes a stack parameter that identifies the determined protocol stack to use in communicating with the respective communication network.

20. A communication device, comprising:
means for selecting a protocol stack from among two or more protocol stacks associated with a subscription for use in communicating with a communication network; and
means for sending to a modem associated with the selected protocol stack a first attention (AT) command that includes a stack parameter that identifies the selected protocol stack.
